(19) United States
(12) Patent Application Publication
(10) Pub. No.: US 2004/0079592 A1
(43) Pub. Date: Apr. 29, 2004

(54) Elevator shaft door

(76) Inventor: Rolf Borneck, Wesel (DE)

Correspondence Address: WILLIAM COLLARD, COLLARD & ROE, P.C., 1077 NORTHERN BOULEVARD, ROSLYN, NY, 11576, US

(21) Appl. No.: 10/615,199

(22) Filed: Jul. 8, 2003

(30) Foreign Application Priority Data
Jul. 8, 2002 (DE) 102 30 799.7

(51) Int. Cl. B66B 13/02

(52) U.S. Cl. 187/318; 49/120

(57) ABSTRACT

An elevator shaft door having a door part that comprises two panels, which are suspended on rolling carriages and guided at the bottom. These door parts perform movements of different length in the same direction during an opening and closing movement, and during these movements move past one another on parallel tracks, with a changing overlap. The rolling carriage of the panel that moves ahead during a closing movement is attached to the ends of a tension cable that is fixed in place, which is guided around deflection rollers that are mounted to rotate on the rolling carriage of the other panel, which moves behind. The deflection rollers are arranged to rotate around vertical axes of rotation and have different diameters. The ends of the tension cable are connected to the back end, in the closing direction, of the rolling carriage, on which the panel that moves ahead is suspended, with a parallel offset, whereby the end of the tension cable that becomes shorter during a closing movement of the panel that moves ahead is guided around a deflection roller having the smaller diameter.

### CROSS REFERENCE TO RELATED APPLICATIONS

This application claims priority under 35 U.S.C. 119 of German Patent Application Serial No. 10230799.7 filed on Jul. 8, 2002 which is incorporated herein by reference.

### BACKGROUND OF THE INVENTION

The invention relates to an elevator shaft door having a door part that comprises two panels, which are suspended on rolling carriages and guided at the bottom, and which perform movements of different length in the same direction during an opening and closing movement. During such movements these panels move past one another on parallel tracks, with a changing overlap, whereby the rolling carriage of the panel that moves ahead during a closing movement is attached to the ends of a tension cable that is fixed in place. This cable is guided around deflection rollers that are mounted to rotate on the rolling carriage of the other panel, which moves behind.

Elevator shaft doors having the structure described are widespread in practical use. The rolling carriages have a rolling wheel arrangement comprising rollers that are guided on rails. The deflection rollers for the tension cable that controls the movement of the panel that moves ahead are mounted to rotate around horizontal axes, on the rolling carriage of the other panel that moves behind. The previously known suspensions of elevator shaft doors require a large installation space above the panels. The upper frame stringer of the door frame must therefore be structured as a broad cover piece on its side that faces away from the elevator shaft and is visible. This impairs the visual or optical appearance of the elevator shaft door and requires a large frame opening for installation of the elevator shaft door. Furthermore, other disadvantages are the large dimensions of the running carriages and the high weight resulting from this design.

The invention is based on the task of creating a tension cable guide system for an elevator shaft door that requires only a small installation height and width.

### SUMMARY OF THE INVENTION

Thus, the invention relates to a modified elevator shaft door which is modified from the door described above. With this design, the deflection rollers are adapted to rotate around vertical axes and have different diameters, wherein the ends of the tension cable are connected, with a parallel offset, to the back end, in the closing direction, of the rolling carriage on which the panel that moves ahead is suspended. With this design, the end of the tension cable that becomes shorter during a closing movement of the panel that moves ahead is guided around the deflection roller having the smaller diameter.

The rolling carriage of the panel that moves ahead in the closing direction has a rolling wheel carrier that has rollers mounted on its upper end and the panel suspended on it at its lower end. The end of the tension cable that is guided around the smaller deflection roller is attached to a side of the rolling wheel carrier that faces the rolling carriage of the panel that moves behind. The end of the tension cable that is guided around the larger deflection roller is connected to the side of the rolling wheel carrier that faces away from that side. With this arrangement, the ends of the tension cable that are guided around the deflection rollers can essentially be used to perform displacement movements to their full length. The effective useful length is not restricted by tensioning devices that can be arranged on the end of the tension cable that is guided around the larger deflection roller. Thus, short distances between the axes of the deflection rollers can be used wherein these distances are only slightly greater than the width of the panel.

The rolling carriage of the panel that moves behind in the closing direction also has a rolling wheel carrier that has rollers mounted on its upper end and the panel suspended on it at its lower end. In a preferred embodiment, this rolling wheel carrier has additional horizontal surfaces on its front and back ends, in the closing direction, on which the deflection rollers are mounted. With this design, the horizontal surfaces on the side facing away from the deflection roller can have a reinforcement in the form of a ridge.

In another embodiment of the invention, the rolling wheel carriers comprise a steel sheet and are structured as die-punched parts.

In another embodiment of the invention, the axes of the deflection rollers have a parallel offset, whereby the parallel offset is selected so that all of the segments of the tension cable that is guided around the deflection rollers extend parallel to the running direction of the panels.

### BRIEF DESCRIPTION OF THE DRAWINGS

Other objects and features of the present invention will become apparent from the following detailed description considered in connection with the accompanying drawing which discloses at least one embodiment of the present invention. It should be understood, however, that the drawings are designed for the purpose of illustration only and not as a definition of the limits of the invention.

In the drawings, wherein similar reference characters denote similar elements throughout the several views:

FIG. 1 shows a cross-section through the upper region of an elevator shaft door;

FIG. 2a shows a top view of the object of FIG. 1, without the door frame, in a first opening position;

FIG. 2b shows a top view of the object of FIG. 1 without the door frame in a second opening position; and

FIG. 3 is a side view of the elevator shaft door from viewing direction A in FIG. 2a.

### DETAILED DESCRIPTION OF PREFERRED EMBODIMENTS

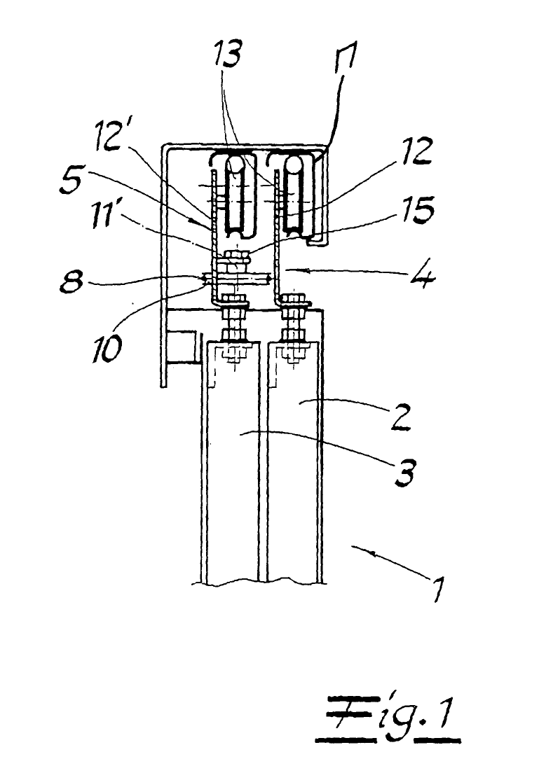

Referring to the drawings, FIG. 1 shows a door part 1 comprising of two panels 2, and 3, which are suspended on rolling carriages 4, and 5 and are guided in a floor rail, not shown, at the bottom. During an opening and closing movement, panels 2, and 3 perform movements of different length in the same direction, and during such movement move past one another on parallel tracks 17, with a changing overlap.

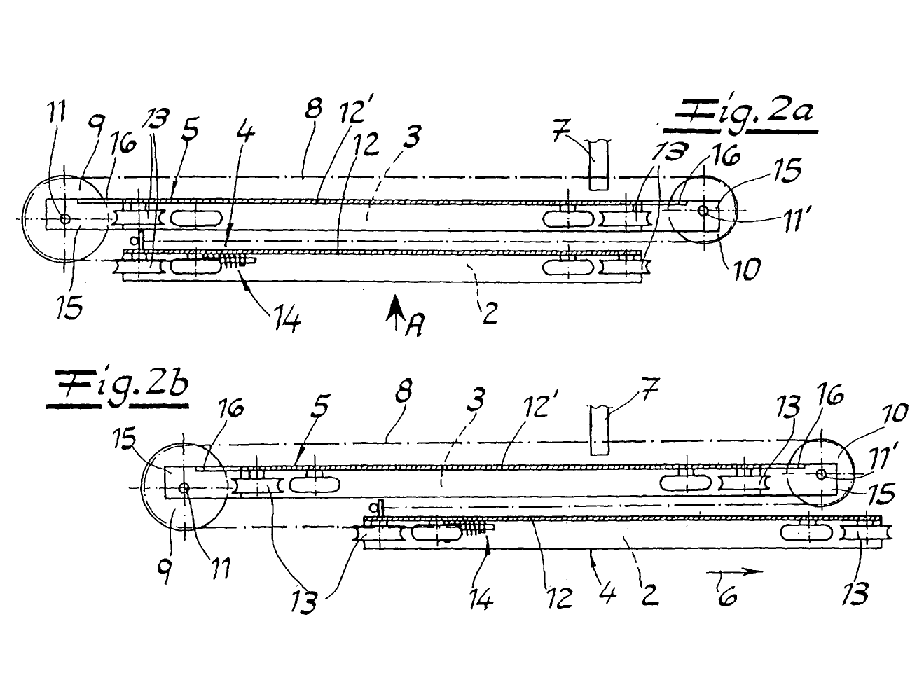

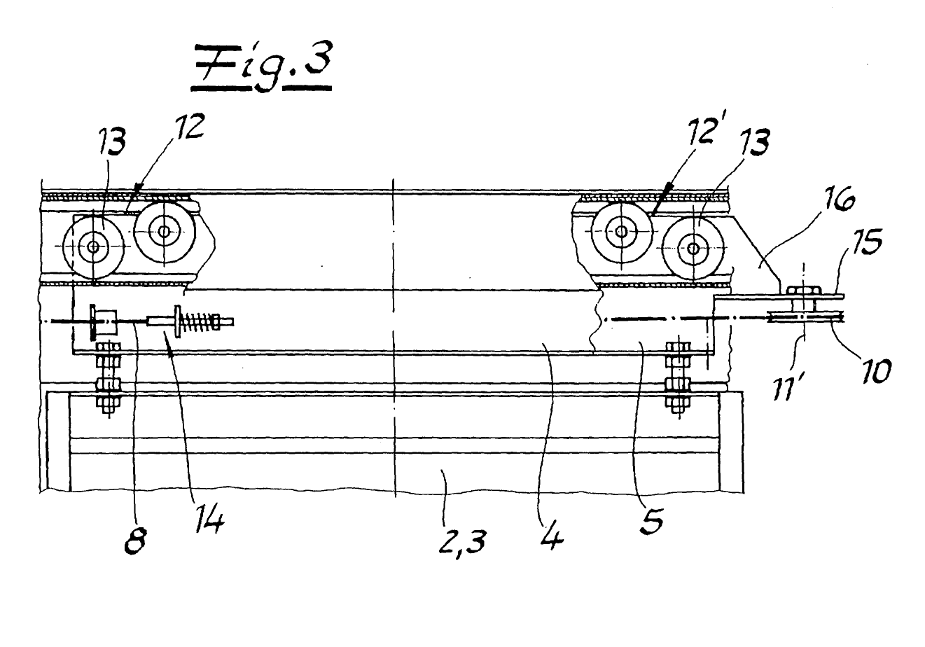

FIGS. 2a and 2b show the direction of the closing movement which is indicated with an arrow 6. When comparing FIGS. 2a and 2b, it is evident that rolling carriage 4 of panel 2 that moves ahead during a closing movement is connected to the ends of a tension cable 8 that is fixed in place, for example by means of a clamp 7. Cable 8 is guided around deflection rollers 9, and 10. Deflection rollers 9, and 10 have different diameters or sizes and are arranged to rotate on rolling carriage 5 of the other panel 3 that moves behind. Deflection rollers 9 and 10 rotate around vertical axes of rotation 11, and 11′, The ends of tension cable 8 are accordingly connected to the back end, in the closing direction, of rolling carriage 4, on which panel 2 that moves ahead is suspended, with a parallel offset. The end of tension cable 8 that becomes shorter during a closing movement of panel 2 that moves ahead in the direction of arrow 6, is guided around smaller deflection roller 10.

Rolling carriage 4, of panel 2, has a rolling wheel carrier 12 that has rollers 13 mounted on its upper end and panel 2 suspended on it at its lower end. The end of tension cable 8 that is guided around smaller deflection roller 10 is attached to a side of rolling wheel carrier 12 that faces rolling carriage 5 of panel 3 that moves behind. The end of tension cable 8 that is guided around larger deflection roller 9 is connected to the side of rolling wheel carrier 12 that faces away from that side. With this arrangement, the ends of tension cable 8 that are guided around deflection rollers 9, and 10 can essentially be used to perform displacement movements to their full length. The effective length is not restricted by tensioning and attachment devices 14 that can be connected to the end of tension cable 8 that is guided around larger deflection roller 9 and arranged on the side of rolling wheel carrier 12 that faces away from that side. FIGS. 2a and 2b show that the structural length of these devices 14 does not restrict the movement path.

Rolling carriage 5 of panel 3 that moves behind in the closing direction, also has a rolling wheel carrier 12′ that has rollers 13 mounted on its upper end, with panel 3 suspended on it at its lower end. This rolling carriage 12′ has additional horizontal surfaces 15 on its front and back ends, in the closing direction, on which deflection rollers 9, and 10 are mounted. With this design, reinforcements, 16 in the form of ridges or similar type structures can be disposed on the side facing away from deflection rollers 9, and 10. Rolling wheel carriers 12, and 12′ for both panels are structured as die-punched parts in the present embodiment.

Finally, it is clear from FIGS. 2a and 2b that axes 11, and 11′ of deflection rollers 9, and 10 have a parallel offset, whereby the parallel offset is selected so that all of the segments of tension cable 8 that is guided around deflection rollers 9, and 10 extend parallel to the running direction of panels 2, and 3.

Accordingly, while at least one embodiment of the present invention have been shown and described, it is to be understood that many changes and modifications may be made thereunto without departing from the spirit and scope of the invention as defined in the appended claims.

What is claimed is:

1. An elevator shaft door disposed in a frame, the door comprising:
a) a plurality of parallel tracks disposed in the frame;
b) a plurality of rolling carriages comprising:
i) at least one rolling carriage for rolling in at least one of said plurality of parallel tracks; and
ii) at least one additional rolling carriage for rolling in at least one of said plurality of parallel tracks;
c) a plurality of panels comprising:
i) at least one panel which is suspended on said at least one rolling carriage;
ii) at least one additional panel which is suspended on said at least one additional rolling carriage;
d) at least one tension cable that is fixed in place, and has ends, wherein said tension cable ends are coupled to said at least one rolling carriage; and
e) a plurality of deflection rollers that are mounted to rotate on said at least one additional rolling carriage, wherein said deflection rollers are adapted to rotate around a vertical axes of rotation and each of said plurality of deflection rollers have a different diameter to form at least one smaller deflection roller and at least one larger deflection roller;
wherein said plurality of panels perform movements of different lengths, in a same direction during an opening and closing movement and move past each other with a changing overlap during said opening and closing movement on said plurality of parallel tracks, wherein ends of said tension cable are connected to a back end of said at least one rolling carriage oriented in the closing direction, wherein at least one end of said at least one tension cable becomes shorter during a closing movement of said at least one panel which moves ahead of said at least one additional panel during said closing movement, and wherein said at least one end of said tension cable is guided around said at least one smaller deflection roller.

2. The elevator shaft door as in claim 1, wherein said at least one rolling carriage has a rolling wheel carrier that has rollers mounted on its upper end to at least one of said plurality of substantially parallel tracks, wherein said end of said at least one tension cable that is guided around said at least one smaller deflection roller is attached to a side of said rolling wheel carrier that faces said at least one additional rolling carriage, and wherein said at least one tension cable has another end that is guided around said at least one larger deflection roller, wherein said another end of said at least one tension cable is connected to a side of said rolling wheel carrier that faces opposite said at least one rolling carriage.

3. The elevator shaft door as in claim 2, wherein said at least one additional rolling carriage has a rolling wheel carrier that has rollers mounted on an upper end of said at least one additional panel, wherein said rolling wheel carrier has at least two additional horizontal surfaces on a front and a back end, based upon a closing direction, of said plurality of panels wherein said at least one smaller deflection roller and said at least one larger deflection roller are each mounted on at least one of said at least two additional horizontal surfaces.

4. The elevator shaft as in claim 3, wherein said at least two horizontal surfaces each have a ridge which forms a reinforcement, wherein said ridge is positioned on a side facing away from said plurality of deflection rollers.

5. The elevator shaft door as in claim 2, wherein said at least one rolling wheel carrier coupled to said at least one rolling carriage comprises a shaped sheet metal profile.

6. The elevator shaft door as in claim 3, wherein said at least one rolling wheel carrier coupled to said at least one additional rolling carriage comprises a shaped sheet metal profile.

7. The elevator shaft as in claim 1, wherein said at least one deflection roller and said at least one additional deflection roller are aligned on two different vertical axes that have a parallel offset, wherein said parallel offset of said two different vertical axes is adapted so that all segments of said at least one tension cable that are guided around said plurality of deflection rollers, extend parallel to a running direction of said plurality of panels.

8. An elevator shaft door disposed in a frame, the frame having a plurality of parallel tracks, comprising:
a) a plurality of rolling carriages for rolling in said plurality of parallel tracks;
b) a plurality of panels with each panel being coupled to and suspended from at least one of said plurality of rolling carriages;
c) a plurality of deflection rollers that are mounted to rotate on at least one of said plurality of rolling carriages, wherein said plurality of deflection rollers are adapted to rotate around vertical axes of rotation; and
d) at least one tension cable that is fixed in place, and has ends, wherein said tension cable ends are coupled to at least one rolling carriage of said plurality of rolling carriages and wherein said tension cable is guided around said plurality of deflection rollers so that said plurality of panels perform opening and closing movement and move past each other with a changing overlap during said opening and closing movements on said plurality of parallel tracks.

9. The door as in claim 8, wherein said ends of said tension cable are connected to a back end of at least one of said plurality of rolling carriages oriented in the closing direction.
